(19) United States
(12) Patent Application Publication
(10) Pub. No.: US 2008/0291993 A1
(43) Pub. Date: Nov. 27, 2008

(54) METHOD FOR JOINT SCALAR QUANTIZATION AND A METHOD FOR ADAPTIVELY ADJUSTING SCALAR QUANTIZATION LEVEL

(75) Inventors: Lihua Li, Beijing (CN); Ping Zhang, Beijing (CN); Xinyu Zhang, Beijing (CN); Ping WU, Beijing (CN); Xiaofeng Tao, Beijing (CN); Hongzhi Guan, Kanagawa (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/126,211

(22) Filed: May 23, 2008

(30) Foreign Application Priority Data
May 24, 2007 (CN) 200710107677.5

(51) Int. Cl. H04B 1/66

(52) U.S. Cl. 375/240

(57) ABSTRACT

A method for joint scalar quantization is disclosed, characterized in that, transforming the original variables into intermediate variables according to a special transforming relationship; according to the variance of the intermediate variables, quantizing, feedbacking and transmitting the intermediate variables; when the original variables are needed, transforming the intermediate variables into the original variables according to the special transforming relationship. Two schemes about the intermediate variables quantization are also provided to adapt to the different system requirements. Further, based on the joint scalar quantization schemes said above, two methods for adaptively adjusting scalar quantization level according to the interrelation among signals are provided.

### TECHNICAL FIELD

The present invention relates to a method for joint scalar quantization and a method for adaptively adjusting scalar quantization level.

### BACKGROUND ART

In the prior art, one dimensional scalar quantization refers to the quantization that performing separate quantization encoding on single sample values, that is to say, separating a sequence of real sample values, that is to say, separating a sequence of real sample values into a set of a limited number of integer value which can be digitally represented. In general, an analog-to-digital converting process can be divided into three steps: sampling step, quantizing step and encoding step.

First, sampling step is performed at a frequency twice larger than the highest frequency of the signals to be sampled according to the Nyqusit theorem.

Second, a layered quantizing step, i.e., a scalar quantizing process for each sample value, is performed on each of the sample values in sequence.

At last, an encoding step is performed on each of the quantized sample values to generate a group of binary codes.

Treating the sample values as being independent with each other, as the biggest disadvantage of scalar quantization, it fails to take the statistical interrelation among the sample values of source into account.

If Q₁ represents one-dimensional scalar quantized codes, it can be expressed mathematically as follows:

Q₁: R¹→{v₁}

Where v₁=0, ±1, ±2, . . . , ±2

### SUMMARY OF THE INVENTION

In view of the drawback of failing to take the statistical interrelation among the sample value of the source into account, the present invention provides a method for adaptively adjusting scalar quantization level according to the interrelation among signals. The method has an advantage of adopting different quantization levels depending on the change of interrelation among signals. Compared with conventional mono-scalar quantization, the present invention is more suitable for the quantization of a plurality of signals having interrelation between them, and moreover has higher quantization efficiency and lower implement complexity.

According to one aspect of the present invention, a method for joint scalar quantization is provided, including the steps:

(1) Transforming original variables X₁ and X₂ into two intermediate variables Y₁ and Y₂ according to the following equation:

$$\begin{matrix}{Y}_{1} = ( {X}_{1} + {X}_{2} ) \\ {Y}_{2} = ( {X}_{1} - {X}_{2} )\end{matrix} \{ \begin{matrix}/ \sqrt{2} \\ / \sqrt{2}\end{matrix}$$

(2) Based on the variance of these intermediate variables, performing quantization, feedback and transmission for these intermediate variables according to the following rules: in the case of the number of quantization bit being kept unchanged, using 2n+1 level to quantize those intermediate variables having larger variance, and using 2n+1 level to quantize those intermediate variables having smaller variance; in the case of the number of quantization bit being decreased, using 2ⁿ level to quantize those intermediate variables having larger variance, and using 2ⁿ⁺¹ level to quantize those intermediate variables having smaller variance. Preferably, the method further comprises a step: when original variables are needed, transforming the intermediate variables into the original variables according to the following equation:

X̅₁=(X₁+X₂)/\sqrt{2}

X̅₂=(X₁−X₂)/\sqrt{2}

Preferably, the originals variables X1 and X2 are random variables which conform to Gauss distribution having a mean value of 0 and a variance of σ².

Preferably, the variance of the intermediate variables can be computed according to the following equation:

$$\begin{matrix}{σ}_{y 1}^{2} = E ( {Y}_{1}^{2} ) - {E}^{2} ( {Y}_{1} ) = E ( \frac{1}{2} {X}_{1}^{2} + \frac{1}{2} {X}_{2}^{2} + {X}_{1} {X}_{2} ) - 0 \\ = {σ}^{2} + E ( {X}_{1} {X}_{2} ) \\ = {σ}^{2} + {ρ}_{{x}_{1} {x}_{2}} {σ}^{2}\end{matrix}$$

$$\begin{matrix}{σ}_{y 2}^{2} = E ( {Y}_{2}^{2} ) - {E}^{2} ( {Y}_{2} ) = E ( \frac{1}{2} {X}_{1}^{2} + \frac{1}{2} {X}_{2}^{2} + {X}_{1} {X}_{2} ) - 0 \\ = {σ}^{2} + E ( {X}_{1} {X}_{2} ) \\ = {σ}^{2} + {ρ}_{{x}_{1} {x}_{2}} {σ}^{2}\end{matrix}$$

Px₁x₂ is the coefficient of two original variables X₁ and X₂

According to another aspect of the present invention, a method for adaptively adjusting scalar quantization level according to the interrelation among variables is provided, comprising steps:

(1) computing a correlation coefficient of two original variables X₁ and X₂;

(2) when an absolute value of the correlation coefficient of two original variables X₁ and X₂ is less than ρ₁(=0.3), performing a separate quantization;

(3) when the absolute value of the correlation coefficient is larger than P₁, transforming the original variables X₁ and X₂ into two intermediate variables Y₁ and Y₂ according to the following equation:

Y₁=(X₁+X₂)/\sqrt{2}

Y₂=(X₁−X₂)/\sqrt{2}

(4) based on the variance of these intermediate variables, using 2ⁿ⁺¹ level to quantize those intermediate variable having larger variance, and using 2²⁻¹ level to quantize those intermediate variable having smaller variance.

According to another aspect of the present invention, a method for adaptively adjusting scalar quantization level according to the interrelation among variables is provided, comprising steps:

(1) computing a correlation coefficient of two original variables X₁ and X₂;

(2) when an absolute value of the correlation coefficient of two original variables X₁ and X₂ is less than ρ₁(=0.3), performing a separate quantization;

(3) when the absolute value of the correlation coefficient is larger than P₁, transforming the original variables X₁ and X₂ into two intermediate variables Y₁ and Y₂ according to the following equation:

Y₁=(X₁+X₂)/\sqrt{2}

Y₂=(X₁−X₂)/\sqrt{2}

(4) when the absolute value of the correlation coefficient is larger than P₁, but less than ρ₂(=0.6), based on the variance of these intermediate variables, using 2ⁿ⁺¹ level to quantize those intermediate variable having larger variance, and using 2¹⁻¹ level to quantize those intermediate variable having smaller variance.

(5) when the absolute value of correlation coefficient is larger than ρ₂, based on the variance of these intermediate variables, using 2″ level to quantize those intermediate variable having larger variance, and using 2ⁿ⁻¹ level to quantize those intermediate variable having smaller variance.

Preferably, the step of computing a correlation coefficient of two original variables X₁ and X₂ further comprises steps:

(1) transmitting side transmitting the data information:

(2) receiving side receiving the data information and performing channel estimation to obtain a channel matrix H=[h₁h₂]

(3) computing the real part correlation coefficient ρ₁=E(Re(h₁)·(Re(h₂))/σ² among channel elements, and the imaginary part correlation coefficient ρ_{Q}=E(Im(h₁)·(Im(h₂))/σ² respectively, wherein RE( ) and n( ) represents taking the real part and imaginary part respectively.

Preferably, the method for adaptively adjusting scalar quantization level further comprises the steps:

Feedbacking quantized channel information to the transmitting side at a frequency of ƒ₁, feedbacking the channel variance and correlation coefficient among channel elements to the transmitting side at a frequency of ƒ₂(ƒ₂≦ƒ₁);

At the transmitting side, determining the quantization method and the number of quantization level that have been used, based on the magnitude and positive or negative symbol of the feedback correlation coefficient among channel elements, and computing quantization level of the joint quantization or separate quantization based on the feedback channel variance and feedback correlation coefficient among channel elements.

### DESCRIPTION OF DRAWINGS

FIG. 1 is a block diagram of a method for adaptively adjusting scalar quantization level in accordance with the present invention;

FIG. 2 is a flowchart of the method for adaptively adjusting scalar quantization level in accordance with an embodiment of the present invention;

FIG. 3 is a flowchart of the method for adaptively adjusting scalar quantization level in accordance with another embodiment of the present invention.

### SPECIFIC MODE FOR CARRYING OUT THE INVENTION

According to the present invention, assume two original signal variables as X₁ and X₂, which are random variables conforming to Gauss distribution, having a mean value of 0 and a variance of σ². If the two variables are independent with each other, they can be quantized with classical optimal scalar quantizer, separately. However, when they are interrelated, performing separate quantization with classical scalar quantizer may decrease the quantization efficiency. Accordingly, the present invention set forth a scalar quantization method called joint scalar quantization, which is suitable for variables having interrelation among them. The method can be divided into three steps:

At first step, two intermediate variables Y₁ and Y₂ are obtained through expression (1) from the original variables X₁ and X₂.

$$\{ \begin{matrix}{Y}_{1} = ( {X}_{1} + {X}_{2} ) / \sqrt{2} \\ {Y}_{2} = {X}_{1} - {X}_{2} ) / \sqrt{2}\end{matrix} \qquad ( 1 )$$

Based upon a theory analysis, Y₁ and Y₂ are independent with each other. In accordance with the analysis, the variance of Y₁ and Y₂ is:

$$\begin{matrix}{σ}_{y 1}^{2} = E ( {Y}_{1}^{2} ) - {E}^{2} ( {Y}_{1} ) = E ( \frac{1}{2} {X}_{1}^{2} + \frac{1}{2} {X}_{2}^{2} + {X}_{1} {X}_{2} ) - 0 \\ = {σ}^{2} + E ( {X}_{1} {X}_{2} ) \\ = {σ}^{2} + {ρ}_{{x}_{1} {x}_{2}} {σ}^{2}\end{matrix}$$

$$\begin{matrix}{σ}_{y 2}^{2} = E ( {Y}_{2}^{2} ) - {E}^{2} ( {Y}_{2} ) = E ( \frac{1}{2} {X}_{1}^{2} + \frac{1}{2} {X}_{2}^{2} + {X}_{1} {X}_{2} ) - 0 \\ = {σ}^{2} + E ( {X}_{1} {X}_{2} ) \\ = {σ}^{2} + {ρ}_{{x}_{1} {x}_{2}} {σ}^{2}\end{matrix}$$

It can be seen that Y₁ and Y₂ conform to Gauss distribution with a mean value of 0, but having none zero variance. Therefore, the quantization level is multiplied by the corresponding σ_{y1} or σ_{y2} to obtain the levels required to quantize Y₁ and Y₂. After the quantization of Y₁ and Y₂, Y̅₁ and Y̅₂ are obtained as the result of the quantization. The feedback transmission of X₁ and X₂ are transformed as the feedback transmission of Y̅₁ and Y̅₂, whereby the quantization errors or feedback bits can be decreased.

At second step, intermediate variables Y₁ and Y₂ are quantized, specifically, there are two following schemes to set the quantization level:

Scheme 1: A Scheme With Constant Quantized Bits Number

If the conventional quantization uses a 2ⁿ level optimal quantizer, quantizing a single signal element requires n bits. To keep the number of quantized bits constant, in the joint scalar quantization, the signal elements having larger variance are quantized by 2ⁿ⁺¹ level, and the elements having smaller variance are quantized by 2ⁿ⁻¹ level. That is, if the correlation coefficient ρₓ_{₁}ₓ_{₂} is larger than zero, Y₁ is quantized using 2ⁿ⁺¹ level and Y₂ is quantized using 2ⁿ⁻¹ level. On the contrary, if the correlation coefficient ρₓ_{₁}ₓ_{₂} is smaller than zero, Y₂ is quantized using 2ⁿ⁺¹ and Y₁ is quantized using 2ⁿ⁻¹ level. Thus the average bits number required to quantize each element is still n bits. When feedbacking quantized channel information to the transmitting side, in the case of a constant feedback amount, the accuracy of the quantization may be improved effectively.

Scheme 2: A Scheme With Decreased Quantized Bits Number

To save feedback bits, intermediate variable having larger variance may be quantized using 2ⁿ level, and intermediate variable having smaller variance may be quantized using 2ⁿ⁻¹ level. That is, if the correlation coefficient ρₓ_{₁}ₓ_{₂} is larger than zero, Y₁ is quantized using 2ⁿ level and Y₂ is quantized using 2ⁿ⁻¹ level. On the contrary, if the correlation coefficient ρₓ_{₁}ₓ_{₂} is smaller than zero, Y₂ is quantized using 2ⁿ level and Y₁ is quantized using 2ⁿ⁻¹ level.

With a numerical calculation, it can be determined that the quantization accuracy of scheme 1 is gradually higher than the conventional optimal quantization when the absolute value of the correlation coefficient of the two variables is larger than 0.3. When the absolute value of the correlation coefficient is larger than 0.6, the performance of scheme 2 is still better than the conventional method. Further, the performance of scheme 1 is always better than scheme 2. The quantization schemes can be selected depending on the system requirements. At third step, when original variables are needed, the quantization results of the original variables X₁ and X₂ are obtained through a transformation expression (2):

$$\{ \begin{matrix}{\overline{X}}_{1} = ( {\overline{Y}}_{1} + {\overline{Y}}_{2} ) / \sqrt{2} \\ {\overline{X}}_{2} = {\overline{Y}}_{1} - {\overline{Y}}_{2} ) / \sqrt{2}\end{matrix} \qquad ( 2 )$$

According to the method for joint scalar quantization as said above, the present invention provides methods for adaptively adjusting scalar quantization level according to the interrelation among variables, comprising:

(1) computing a correlation coefficient of two variables, when an absolute value of the correlation coefficient of the two variables is less than ρ₁(=0.3), performing a separate quantization; when an absolute value of the correlation coefficient of the two variables is larger than ρ₁, using scheme 1 of the joint scalar quantization;

(2) computing a correlation coefficient of two variables, when the absolute value of the correlation coefficient of the two variables is less than ρ₁(=0.3), performing a separate quantization; when the absolute value of the correlation coefficient is larger than ρ₁, using scheme 1 of the joint scalar quantization; when the absolute value of the correlation coefficient is larger than ρ₂(=0.6), using scheme 2 of the joint scalar quantization.

Furthermore, if the original variables X₁ and X₂ are complex numbers, the above process is performed on their real parts and imaginary parts respectively. Hereinafter, an embodiment of the present invention will be described with reference to the drawings. In a closed-loop MIMO system, the transmitting side often needs to know all or a portion of the channel information to improve the system performance. Hence, the joint signal quantization method of this invention can be used to quantize and feedback MIMO channel information. It is assumed that the number of antennae on the transmitting side is 2, and the number of antennae on the receiving side is 1. A weighted method is adopted to send data information. Based upon the above system parameters, the steps of the present invention are as follows:

Step 1: the transmitting side transmitting the data information; the receiving side receiving the data information and performing channel estimation to obtain a channel matrix H=[h₁, h₂]; based on H, the real part correlation coefficient ρ₁=E(Re(h₁))·(Re(h₂))/σ² among channel elements, and the imaginary part correlation coefficient ρ_{Q}=E(Im(h₁))·(Im(h₂))σ² are calculated, respectively, wherein Re( ) and Im( ) represents taking the real part and imaginary part, respectively.

Step 2: quantizating the real part and the imaginary part of the channel information, respectively.

For the real part:

When the system requires higher quantization performance, method (1) of the present invention as said above is adopted.

The channel element correlation coefficient ρ₁ and ρ_{Q} obtained at step 1 is compared with a threshold. When the absolute value of the correlation coefficient is less than ρ₁(=0.3), a separate quantization is performed, and when the absolute value of the correlation coefficient of the two variables is larger than ρ₁, the scheme 1 of the joint scalar quantization method is adopted.

If the system needs to reduce the number of quantized bits, the method (2) of this invention is adopted. The channel element correlation coefficient ρ₁ and ρ_{Q} obtained at step 1 is compared with a threshold. When the absolute value of the correlation coefficient is less than ρ₁(=0.3), a separate quantization is performed, and when the absolute value of the correlation coefficient of the two variables is larger than ρ₁, but less than ρ₂(=0.6), the scheme 1 of the joint scalar quantization method is adopted. When the absolute value of the correlation coefficient is larger than ρ₂, the scheme 2 of the joint scalar quantization method is adopted.

Step 3: feedbacking quantized channel information to the transmitting side at a frequency of ƒ₁, feedbacking the channel variance and correlation coefficient among channel elements to the transmitting side at a frequency of ƒ₂(ƒ₂≦ƒ₁) (such signaling information can be feedbacked once in a longer period).

Step 4: at the transmitting side, based on the magnitude and positive or negative symbol of the feedback correlation coefficient among channel elements, determining the quantization method and the number of quantization level that have been used, and computing quantization level of the joint quantization or separate quantization based on the feedback channel variance and feedback correlation coefficient among channel elements. Restoring the original channel information according to the analysis as said above, and then based on the information, calculating a vector for weighted transmission.

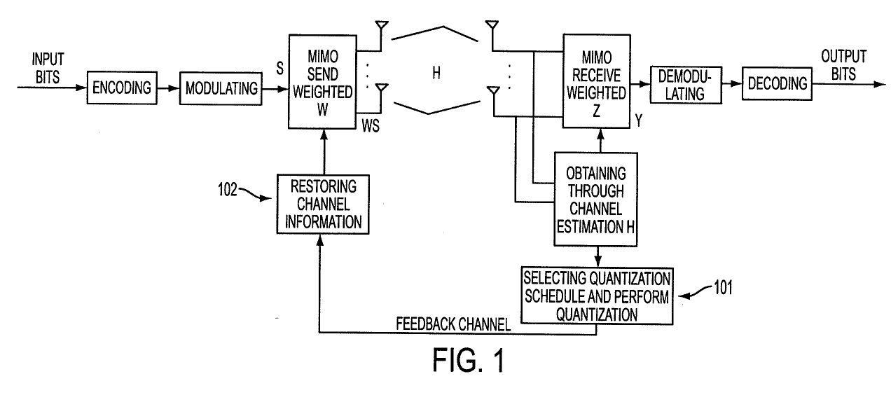

FIG. 1 is a block diagram of the method for adaptively adjusting scalar quantization level in accordance with the present invention. In FIG. 1, according to the channel information, the transmitting side transmits weighted data to the receiving side through MIMO channel. The receiving side obtains the channel matrix H after channel estimation, and then calculates the correlation coefficient of the channel elements and the channel variance, then determines the quantization scheme used to feedback the channel information, then feedbacks through signaling channel, the correlation coefficient of the channel elements and the channel variance to the transmitting side at a certain period. After the quantization of the channel information, the quantized bits are feedbacked to the transmitting side restores the channel information, and prepares for the next transmission.

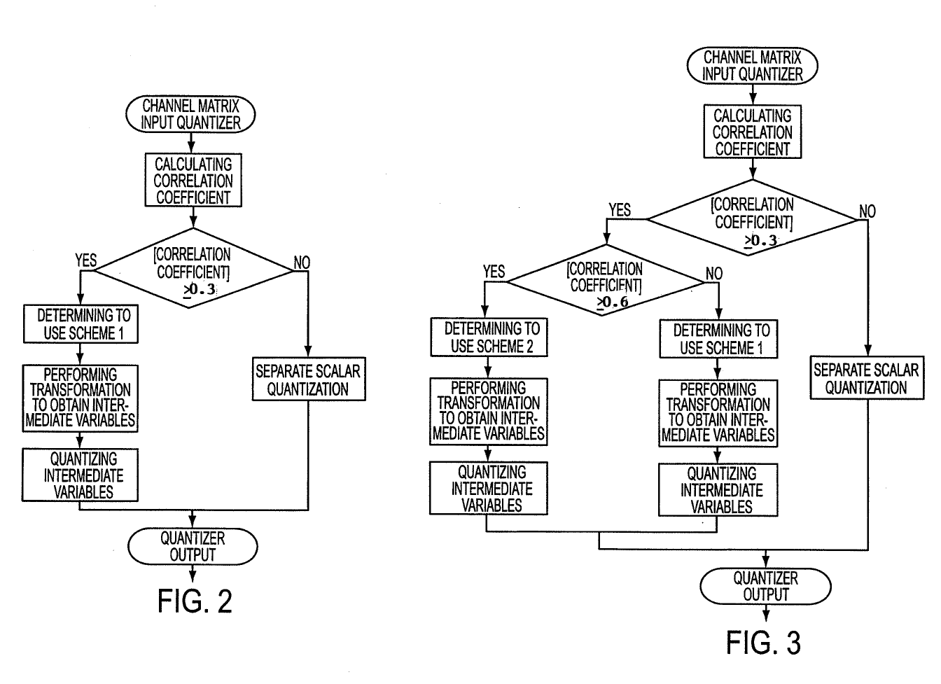

There are two methods illustrated in FIGS. 2 and 3 respectively to implement the portion 101 in the FIG. 1. Wherein, FIG. 2 is a flowchart of the method for adaptively adjusting scalar quantization level in accordance with an embodiment of the present invention, and FIG. 3 is a flowchart of the method for adaptively adjusting scalar quantization level in accordance with another embodiment of the present invention.

In sum, the present invention provides a method, i.e., a joint scalar quantization method, which can improve the quantization accuracy when two variables have interrelation between them. This method can improve the quantization accuracy and reduce the implement complexity by overcoming the flaws of the conventional separate scalar quantization, such as failing to take the statistical interrelation among the sample value of the source into account.

1. A method for joint scalar quantization, comprising the steps of:
(1) transforming originals variables ^{X}₁ and ^{X}₂ into two intermediate variables ^{Y}₁ and ^{Y}₂ according to the following equation:
$$\{ \begin{matrix}{Y}_{1} = ( {X}_{1} + {X}_{2} ) / \sqrt{2} \\ {Y}_{2} = ( {X}_{1} - {X}_{2} ) / \sqrt{2}\end{matrix}$$
(2) based on the variance of these intermediate variables, performing quantization, feedback and transmission for these intermediate variables according to the following rules:
in the case of the number of quantization bit being kept unchanged, using 2 level to quantize those intermediate variable having larger variance, and using 2 level to quantize those intermediate variables having smaller variance;
in the case of the number of quantization bit being decreased, using 2 level to quantize those intermediate variables having larger variance, and using 2 level to quantize those intermediate variables having smaller variance.

2. The method as claimed by claim 1, further comprising the step: when original variables are needed, transforming the intermediate variables into the original variables according to the following equation:
$$\{ \begin{matrix}\overline{X 1 = ( \overline{Y 1 + Y 2} )} / \sqrt{2} \\ \overline{X 2 =} ( Y 1 - Y 2 ) / \sqrt{2}\end{matrix}$$

3. The method as claimed by claim 1, wherein the original variables X1 and X2 are random variables which conform to Gauss distribution having a mean value of 0, and a variance of σ².

4. The method as claimed by claim 1, wherein computing the variance of the intermediate variables according to the following equation:
$$\begin{matrix}{σ}_{y 1}^{2} = E ( {Y}_{1}^{2} ) - {E}^{2} ( {Y}_{1} ) = E ( \frac{1}{2} {X}_{1}^{2} + \frac{1}{2} {X}_{2}^{2} + {X}_{1} {X}_{2} ) - 0 \\ = {σ}^{2} + E ( {X}_{1} {X}_{2} ) \\ = {σ}^{2} + {ρ}_{{x}_{1} {x}_{2}} {σ}^{2}\end{matrix}$$
$$\begin{matrix}{σ}_{y 2}^{2} = E ( {Y}_{2}^{2} ) - {E}^{2} ( {Y}_{2} ) = E ( \frac{1}{2} {X}_{1}^{2} + \frac{1}{2} {X}_{2}^{2} + {X}_{1} {X}_{2} ) - 0 \\ = {σ}^{2} + E ( {X}_{1} {X}_{2} ) \\ = {σ}^{2} + {ρ}_{{x}_{1} {x}_{2}} {σ}^{2}\end{matrix}$$
where the correlation coefficient Px₁x₂ is defined as:
Px₁x₂=E(X₁X₂)/σ²−1SPx₁x₂S1

5. A method for adaptively adjusting scalar quantization level according tot he interrelation among variables, comprising steps:
(1) computing a correlation coefficient of two original variables ^{X}^{₁} and ^{X}^{₂};
(2) when an absolute value of the correlation coefficient of two original variables ^{X}^{₁} and ^{X}^{₂} is less than ^{ρ}^{_{1(=0.3)}}, performing a separate quantization;
(3) when the absolute value of the correlation coefficient is larger than ^{ρ}^{₁}, transforming the original variables ^{X}^{₁} and ^{X}^{₂} into two intermediate variables Y1 and ^{Y}^{₂} according to the following equation:
Y₁=(X₁+X₂)/\sqrt{2}
Y₂=(X₁−X₂)/\sqrt{2}
(4) based on the variance of these intermediate variables, using 2²⁺¹ level to quantize those intermediate variables having larger variance, and using 2ⁿ⁻¹ level to quantize those intermediate variables having smaller variance.

6. A method for adaptively adjusting scalar quantization level according to the interrelation among variables, comprising the steps of:
(1) computing a correlation coefficient of two original variables ^{X}^{₁} and ^{X}^{₂};
(2) when an absolute value of the correlation coefficient of two original variables ^{X}^{₁} and X^{₂} is less than ρ₁(=0.3), performing a separate quantization;
(3) when the absolute value of the correlation coefficient is larger than ^{ρ}^{₁}, transforming the original variables ^{X}^{₁} and ^{X}^{₂} into two intermediate variables ^{Y}^{₁} and ^{Y}^{₂} according to the following equation:
Y₁=(X₁+X₂)/\sqrt{2}
Y₂=(X₁−X₂)/\sqrt{2}
(4) when the absolute value of the correlation coefficient is larger than ^{P}^{₁} but less than ρ₂(=0.6), based on the variance of these intermediate variables, using 2ⁿ⁺¹ level to quantize those intermediate variables having larger variance, and using 2¹⁻¹ level to quantize those intermediate variables having smaller variance;
(5) when the absolute value of the correlation coefficient is larger than ^{P}^{₂}, based on the variance of these intermediate variables, using 2ⁿ level to quantize those intermediate variables having larger variance, and using 2ⁿ⁻¹ level to quantize those intermediate variables having smaller variance.

7. The method as claimed by claim 5, wherein the step of computing a correlation coefficient of two original variables ^{X}^{₁} and ^{X}^{₂} further comprising:
(1) transmitting side transmitting the data information;
(2) receiving side receiving the data information and performing channel estimation to obtain a channel matrix ^{H=[h}^{₁}^{h}^{₂}];
(3) computing the real part correlation coefficient ρ₁=E(Re(h₁)·(Re(h₂ ))/σ² among channel elements, and the imaginary part correlation coefficient
ρ_{Q}=E(Im(h₁)·Im(h₂))/σ² among channel elements,
respectively, wherein ^{Re(·)} and ^{Im(·)} represents taking the real part and imaginary part, respectively.

8. The method as claimed by claim 5, further comprising:
feedbacking quantized channel information to the transmitting side at a frequency of ^{ƒ}^{₁},
feedbacking the channel variance and correlation coefficient among channel elements to the transmitting side, determining the quantization method and the number of quantization level that have been used, based on the magnitude and the positive or negative symbol of the feedback correlation coefficient among channel elements, and
computing quantization level of the joint quantization or separate quantization, based on the feedback channel variance and feedback correlation coefficient among channel elements.
